(19) United States
(12) Patent Application Publication
(10) Pub. No.: US 2017/0225663 A1
(43) Pub. Date: Aug. 10, 2017

(54) HYDRAULIC JACK SYSTEM FOR A MOTOR VEHICLE

(71) Applicant: Lance Sanchez, Battle Ground, WA (US)

(72) Inventor: Lance Sanchez, Battle Ground, WA (US)

(21) Appl. No.: 15/015,342

(22) Filed: Feb. 4, 2016

(51) Int. Cl. B60S 9/12

(52) U.S. Cl. CPC B60S 9/12

(57) ABSTRACT

A hydraulic jack system for a motor vehicle that includes: a control panel; a hydraulic pump; a lifting panel, where the lifting panel includes four sides; a plurality of hydraulic jacks on at least two sides of the lifting panels; and a power source. The hydraulic jack system according to claim 1, where a bracket secures the each hydraulic jack to a respective side of the lifting panel. The hydraulic jack system according to claim 1, where each hydraulic jack includes a pedestal. The hydraulic jack system according to claim 1, where each pedestal includes a foot plate.

### BACKGROUND OF THE INVENTION

### Field of Invention

The present invention relates to a hydraulic jack system installed in for supporting and lifting a motor vehicle.

### Description of Related Art

One aspect of motor vehicle operations involves the inconsequential tire repair and changing. In order to remove a tire, the motor vehicle must be lifted typically through the means of a jack. A jack is typically a hand-held device that is placed under the frame of the motor vehicle to raise the wheel and a portion of the vehicle off the ground. This process of using a jack involves some manual labor for the removal of the wheel and may be difficult for some individuals. When using a conventional jack a risk exists of the jack slipping out of place and therefore causing injury to the user. As a result, it would be advantageous to have a system where the jack is installed for automatic lifting purposes.

### SUMMARY OF THE INVENTION

The present invention relates to a hydraulic jack system for a motor vehicle that includes: a control panel; a hydraulic pump; a lifting panel, where the lifting panel includes four sides; a plurality of hydraulic jacks on at least two sides of the lifting panels; and a power source. The hydraulic jack system according to claim 1, where a bracket secures the each hydraulic jack to a respective side of the lifting panel. The hydraulic jack system according to claim 1, where each hydraulic jack includes a pedestal. The hydraulic jack system according to claim 1, where each pedestal includes a foot plate.

### BRIEF DESCRIPTION OF DRAWINGS

FIG. 1 depicts a hydraulic jack system in accordance with the present invention.

### DETAILED DESCRIPTION

The present invention elects to a hydraulic jack system that implements a series of hydraulic jacks on two sides of a lifting panel. The lifting panel is installed under the chassis of a motor vehicle and is aligned to appropriately enable the lifting of a wheel of the motor vehicle. Preferably, jacks are provided on two sides of the lifting panel and are installed through the use of mounting brackets. The control panel controls movement of a hydraulic pump that provides lifting power for each jack on the lifting panel. A power source is also provided that supplies power to the pump.

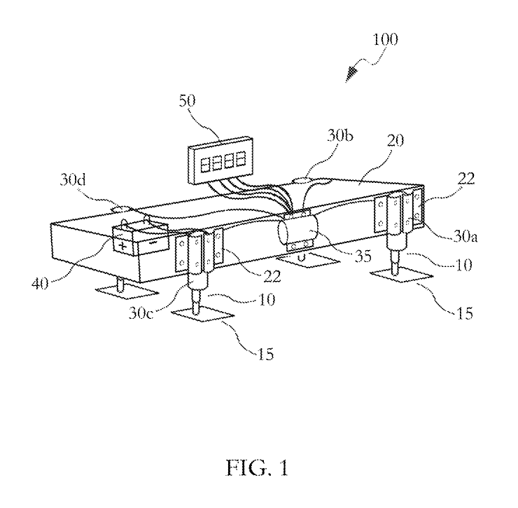

In reference to FIG. 1, a hydraulic jack system according to present invention is depicted. This hydraulic jack system includes a control panel 50 that controls a pump 35 installed on a lifting panel 20. The control panel 50 may be installed anywhere within the vehicle so that the user may have access thereto. The hydraulic pump 35 transfers hydraulic fluid to each respective hydraulic jack shown on the two sides of the lifting panel 20. A bracket 22 is used to attach each respective hydraulic jack into place. Hydraulic pumps 30a, 30b, 30c and 30d are evenly distributed on two sides of the lifting panel 20. As shown, each hydraulic jack includes a pedestal 10 preferably with a foot plate 15. An additional feature of the present invention is the power source 40 that may be in the form of a battery used to supply power to hydraulic pump 35. During use the user may activate a jack on the other side of the lifting panel in order to lift a particular area of the vehicle. Preferably the jacks are provided on two sides of the lifting panel however further jacks may be installed as needed to provide other lifting capability. The instant invention has been shown and described in what it considers to be the most practical and preferred embodiments. It is recognized, however, that departures may be made there from within the scope of the invention and that obvious modifications will occur to a person skilled in the art.

1. A hydraulic jack system for a motor vehicle comprising:
a. a control panel;
b. a hydraulic pump;
c. a lifting panel, where the lifting panel includes four sides;
d. a plurality of hydraulic jacks on at least two sides of the lifting panels, where each hydraulic jack includes a pedestal with a foot plate; and
e. a power source.

2. The hydraulic jack system according to claim 1, where a bracket secures the each hydraulic jack to a respective side of the lifting panel.

3. (canceled)

4. (canceled)
